(19) United States
(12) Patent Application Publication
(10) Pub. No.: US 2015/0346493 A1
(43) Pub. Date: Dec. 3, 2015

(54) SEE-THROUGH DISPLAY DEVICE CAPABLE OF ENSURING AMBIENT FIELD-OF-VIEW

(71) Applicant: GREEN OPTICS CO., LTD., Chungcheongbuk-do (KR)

(72) Inventors: Jang-Ho CHOI, Chungcheongbuk-do (KR); Dong-Kyun KIM, Chungcheongbuk-do (KR); Sang-Jun LEE, Chungcheongbuk-do (KR); Seon-Young RYU, Chungcheongbuk-do (KR)

(21) Appl. No.: 14/504,446

(22) Filed: Oct. 2, 2014

(30) Foreign Application Priority Data
May 27, 2014 (KR) 10-2014-0063763

(51) Int. Cl. G02B 27/01; G02B 5/30; G02B 27/28; G02B 5/04

(52) U.S. Cl. CPC G02B 27/0172; G02B 5/04; G02B 5/3083; G02B 27/283; G02B 2027/0178

(57) ABSTRACT

There is provided a see-through display device capable of ensuring an ambient field-of-view which includes a display control board; a display device configured to emit image light according to an image signal generated in the display control board; a first prism that is located on a bottom surface of the display device, and a second emission surface perpendicular to the incident surface; a partial reflection filter configured to reflect some image light emitted from the first prism and penetrate the remaining image light; and a second prism that is located on a bottom surface of the partial reflection filter, has a length greater than the interocular distance, and in which an incident surface having the same angle as the emission surface of the first prism, a curved reflection surface in which image light incident on the incident surface is reflected with positive power.

### CROSS-REFERENCE TO RELATED APPLICATION

This application claims priority to and the benefit of Korean Patent Application No. 2014-0063763, filed on May 27, 2014, the disclosure of which is incorporated herein by reference in its entirety.

### BACKGROUND

1. Field of the Invention

The present invention relates to a see-through image display device, and particularly, to a see-through display device capable of ensuring an ambient field-of-view in which a wide and open forward situation may be recognized similar to a natural state in which there is no obstacle in a visible region between the eyes.

2. Discussion of Related Art

In general, a display device is an image display device in which image light generated from a position very close to eyes is provided to form a focus using a precise optical device such that a virtual large screen is configured at a further distance and a user can view an enlarged virtual image. The display device is classified as a see-close device in which an ambient environment is invisible and only image light emitted from the display device is visible, or a see-through device in which an ambient environment is visible through a window, and at the same time, image light emitted from the display device is visible. FIG. 1 illustrates an example of a see-through display device in the related art.

First, FIG. 1 illustrates an optical system of a see-through and eye glass type display device disclosed in JP2004101197A (Apr. 2, 2004) in the related art. The see-through and eye glass type display device includes a light source 3, a display device 4, a partial reflection plate 5, and a curved mirror 6.

In the related art, a beam emitted from the light source 3 passes through the display panel 4 and is converted into image light. Some image light penetrates the partial reflection plate 5 and some image light is reflected. Image light is reflected with positive power at the curved mirror 6 provided in the front. Some image light is reflected at the partial reflection plate 5 again toward the display device 4, and the remaining light penetrates the partial reflection plate 5 and forms an image on the user's pupil as an enlarged image.

However, in such a method in the related art, when a size of the beam emitted from the light source is assumed to be 100, a beam intensity decreases at the partial reflection plate 5 and the curved mirror 6 by 50% and decreases by 50% again when the beam penetrates the partial reflection plate 5. Therefore, only 12.5% of the intensity with respect to an initial beam intensity is delivered to the user's pupil. Therefore, light efficiency is very low, and since a light loss in surface reflection is additionally generated according to the number of reflections and penetrations, light efficiency further decreases. Further, since the curved mirror 6 is disposed in front of the user, when goggles are formed, a thickness of the goggles increases. As a result, a volume and a weight increase, and a center of gravity is further away from the user. When the user wears an eye glass type device, wearing is very inconvenient for the user due to a load on his or her nose resulting from its weight.

Also, in the related art, since a screen for both left and right eyes should be formed as a coaxial optical system using a reflector, it is not possible to provide one curved mirror for the eyes and a curved mirror should be provided for each of the left and right eyes. This can be understood from a picture of a see-through display device in the related art in FIG. 2.

As illustrated in FIG. 2, a housing fixing each curved mirror and a partial reflection plate should be provided between curved mirrors for both left and right eyes, and the device has a structure in which a left eye and a right eye independently view an image output from the display. No problem occurs in this structure when a virtual image reflected at the curved mirror is viewed. However, when an external image that penetrates the curved mirror and partial reflection plate and is delivered is viewed, a barrier exists due to the housing near the center of the eyes. Therefore, only an external image of a limited region may be viewed and the user may become frustrated. When this display device is used outdoors, a blind spot may occur, which may result in an accident.

FIG. 3A is a diagram simply illustrating a top view of a see-through display device in the related art in order to describe the above-described phenomenon of field-of-view occlusion between the eyes. FIG. 3B is a diagram illustrating a shape of an external image penetrating the see-through display device as in FIG. 3A.

As illustrated in FIG. 3A, when a view is fixed in front of a center of eyes, his or her field-of-view is about 90 degrees corresponding to an angle b. However, when the see-through display device in FIG. 2 is worn, the user may ensure only a field-of-view corresponding to an angle a among an external image 31 for the eyes due to the curved mirror and the housing disposed in front of the eyes. A region in which images that may be viewed normally by the eyes overlap is limited to a region c. Therefore, the user may become very frustrated by the crowded center, and when this device is used for a long time while images viewed by the eyes are different, the user's eyes may easily become tired and dizzy.

In addition, when such a see-through display device is used, there is a problem in that the user has a limited external view resulting from a sense of occurrence of a gap of an amount a at the center of the eyes, as illustrated in FIG. 3B.

### SUMMARY OF THE INVENTION

In view of the above-described problems, the present invention provides a see-through display device capable of ensuring an ambient field-of-view that is able to recognize wide and open forward situation similar to a natural state in which there is no obstacle in a visible region between the eyes.

The present invention also provides a see-through display device that has an efficient beam inducing structure and is able to obtain a bright and clear image.

The present invention also provides a see-through display device capable of implementing a 3D image according to simultaneously providing of image light to the eyes.

The present invention also provides a see-through display device in which an optical module is simultaneously responsible for the eyes, its own window function is enabled, and a separate housing is unnecessary, thereby decreasing a weight and a volume, simplifying assembly, and decreasing a manufacturing cost and a product cost per unit.

According to an aspect of the present invention, there is provided a see-through display device capable of ensuring an ambient field-of-view. The device includes a display control board; a display device configured to emit image light according to an image signal generated in the display control board; a first prism that is located on a bottom surface of the display device, has a length greater than an interocular distance, and includes an incident surface in parallel with the display device, an oblique first emission surface from which image light that has perpendicularly passed through the incident surface is obliquely emitted, and a second emission surface perpendicular to the incident surface; a partial reflection filter configured to reflect some image light emitted from the first prism and penetrate the remaining image light; and a second prism that is located on a bottom surface of the partial reflection filter, has a length greater than the interocular distance, and in which an incident surface having the same angle as the emission surface of the first prism, a curved reflection surface in which image light incident on the incident surface is reflected with positive power and is induced to a user′ pupil, and an emission surface emitting image light to the user's pupil are integrally formed.

Preferably, the emission surface of the first prism, the partial reflection filter, and the incident surface of the second prism may be bonded by an adhesive such that no air gap is generated.

Preferably, the second emission surface of the first prism and the emission surface of the second prism may be disposed in parallel such that a penetrating external image is not distorted or no chromatic aberration is generated.

According to another aspect of the present invention, there is provided a see-through display device capable of ensuring an ambient field-of-view. The device includes a display control board; a display device configured to emit image light according to an image signal generated in the display control board; a first prism that is located on a bottom surface of the display device, has a length greater than an interocular distance, and includes an incident surface in parallel with the display device, and an oblique emission surface from which image light that has perpendicularly passed through the incident surface is obliquely emitted; a partial reflection filter configured to reflect some image light emitted from the first prism and penetrate the remaining image light; a second prism that is located on a bottom surface of the partial reflection filter, has a length greater than the interocular distance, and has an incident surface having the same angle as the emission surface of the first prism; a curved mirror that is located below the second prism, reflects image light emitted from the second prism with positive power, and induces the image light to a user's pupil; and a phase shift film inserted between a bottom surface of the second prism and a top surface of the curved mirror.

Preferably, the partial reflection filter may be a polarization film.

Preferably, the first emission surface of the first prism, the partial reflection filter, and the incident surface of the second prism may be bonded by an adhesive such that no air gap is generated.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a cross-sectional view schematically illustrating an optical system of a see-through display device in the related art;

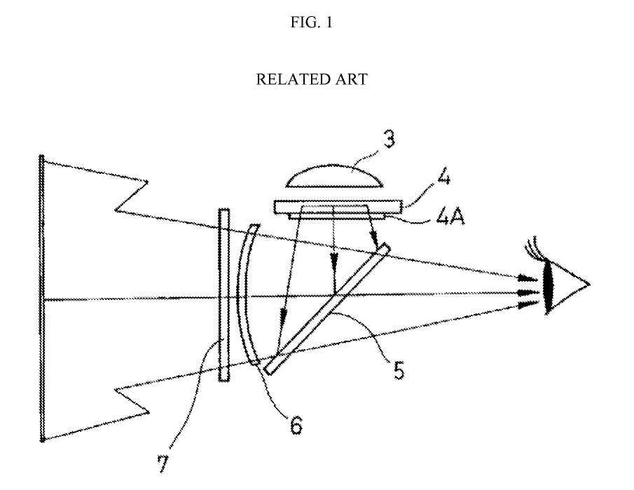

FIG. 2 shows a picture of the see-through display device in the related art;

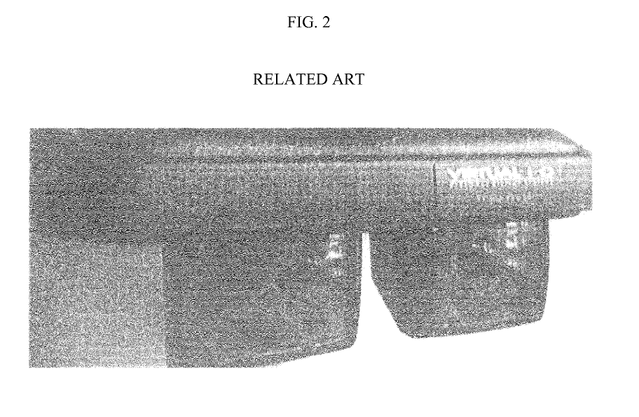

FIG. 3A is a plan view illustrating a phenomenon of field-of-view occlusion between the eyes of the see-through display device in the related art in FIG. 2;

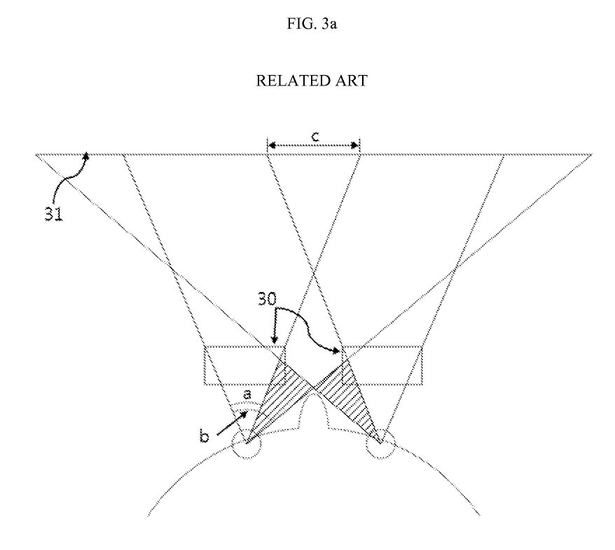

FIG. 3B is a diagram illustrating the phenomenon of field-of-view occlusion between the eyes when the see-through display device in the related art in FIG. 2 is worn;

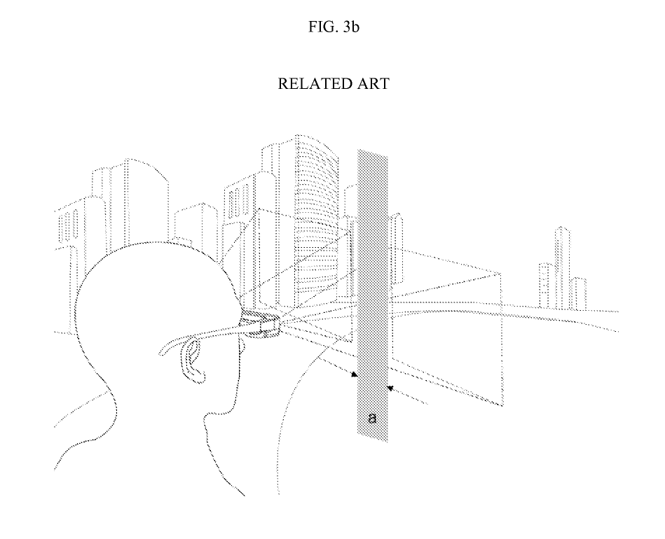

FIG. 4 is an exploded perspective view of a see-through display device capable of ensuring an ambient field-of-view according to an exemplary embodiment of the present invention;

FIG. 5 is a cross-sectional view illustrating an optical path of the see-through display device capable of ensuring an ambient field-of-view according to the present invention;

FIG. 6 is a diagram illustrating a state in which the phenomenon of field-of-view occlusion between the eyes is addressed when the see-through display device capable of ensuring an ambient field-of-view according to the present invention is worn; and

FIG. 7 is an exploded perspective view of a see-through display device capable of ensuring an ambient field-of-view according to another embodiment of the present invention.

### DETAILED DESCRIPTION OF EXEMPLARY EMBODIMENTS

Hereinafter, exemplary embodiments of the present invention will be described with reference to the accompanying diagrams to which detailed descriptions are attached. It should be noted that the same numerals are assigned to the same components in different drawings whenever possible. Detailed specific features are provided in the following description, but these are provided to facilitate overall understanding of the present invention and the present invention is not limited to specific embodiments. It should be understood that the invention is to cover all modifications, equivalents, or alternatives falling within the spirit and scope of the present invention. Also, in description of the present invention, when it is determined that detailed descriptions of related well-known functions or configurations may unnecessarily obscure the gist of the present invention, detailed descriptions thereof will be omitted.

It will be understood that, although the terms first, second, etc may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

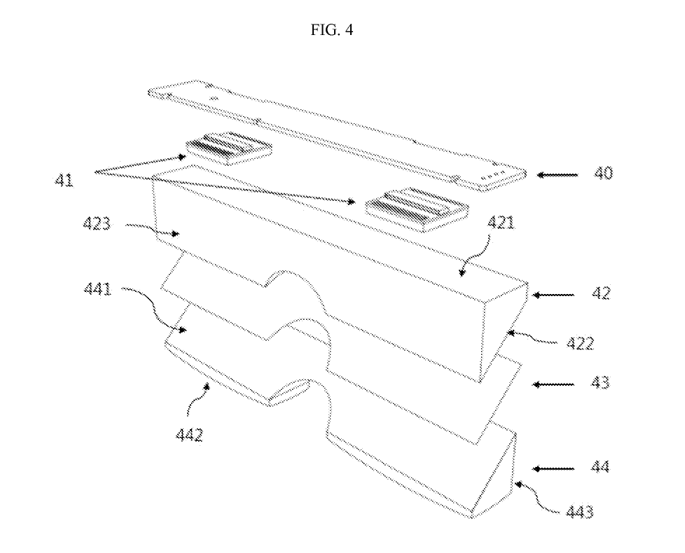

First, FIG. 4 is an exploded perspective view of a see-through display device capable of ensuring an ambient field-of-view according to an exemplary embodiment of the present invention. The see-through display device capable of ensuring an ambient field-of-view according to the present invention includes a display control board 40, two display devices 41, a first prism 42, a partial reflection filter 43, and a second prism 44.

As illustrated in FIG. 4, the first prism 42 includes an incident surface 421 forming a top surface in parallel with the two display devices 41, a first emission surface 422 obliquely formed on a bottom surface of the first prism 42, and a second emission surface 423 that is perpendicularly formed to the incident surface 421 and forms a front surface of the first prism 42.

Also, a top surface of the partial reflection filter 43 is adhered to the first emission surface 422 of the first prism 42. In this case, the partial reflection filter 43 is firmly adhered using an UV adhesive that is generally used to bond lenses such that no air gap is generated in the first emission surface 422 of the first prism 42.

The second prism 44 includes an incident surface 441 adhered to a bottom surface of the partial reflection filter 43, a curved reflection surface 442 forming a bottom surface of the second prism 44, and an emission surface 443 that forms a rear surface of the second prism 44 and emits image light output from the second prism 44 to a user.

As illustrated in FIG. 4, image light emitted from the two display devices 41 according to an image signal generated in the display control board 40 is perpendicularly incident within a prism through the incident surface 421 of the first prism 42 that is located on a bottom surface of the two display devices 41 and has a length greater than an interocular distance, and then emitted from the first prism 42 through the first emission surface 422 that is obliquely disposed.

In the image light emitted from the first prism 42 through the first emission surface 422, a certain amount of the image light is reflected at the partial reflection filter 43, is horizontally incident on the first prism 42 again, and is output externally through the second emission surface 423. The remaining image light that is not reflected at the partial reflection filter 43 penetrates the partial reflection filter 43.

The image light that has penetrated the partial reflection filter 43 is obliquely incident on the incident surface 441 of the second prism 44 that is in contact with the first prism and has a length greater than the interocular distance, is reflected at the curved reflection surface 442 configured such that image light has positive power, and returns in a direction opposite thereto.

The image light that has been reflected at the curved reflection surface 442 and returned passes through the incident surface 441. A certain amount of the image light is reflected at the partial reflection filter 43. The certain amount of the image light reflected at the partial reflection filter 43 is horizontally incident on the incident surface 441 of the second prism 44 again, emitted through the emission surface 443, and forms an image on the user's pupil.

In this case, preferably, the second emission surface 423 of the first prism 42 and the emission surface 443 of the second prism 44 are disposed in parallel such that a penetrating external image is not distorted or no chromatic aberration is generated.

Also, the first emission surface 422 of the first prism 42, the partial reflection filter 43, and the incident surface 441 of the second prism 44 are firmly bonded by an adhesive such that no air gap is generated. Compared to a beam splitter method in the related art, no surface reflection occurs in all penetration and reflection operations along an optical path. Therefore, light efficiency is significantly increased.

Meanwhile, although the two display devices 41 are used in the above embodiment, the embodiment may be also implemented as one display device and a separate optical module that separates an image for both left and right eyes therefrom.

As described above, the first prism 42 and the second prism 44 having a length greater than the interocular distance are made of the same material and body that can simultaneously induce image light for the left eye and image light for the right eye. When these are used, since there is no obstacle between the user's eyes, the phenomenon of field-of-view occlusion is removed. Therefore, when the user views a penetrating external image, external images provided for the left eye and the right eye become the same so that the user's eyes may not become tired, a blind spot in which vision is blocked is removed, and a dangerous situation may be easily recognized even when the user is walking outdoors.

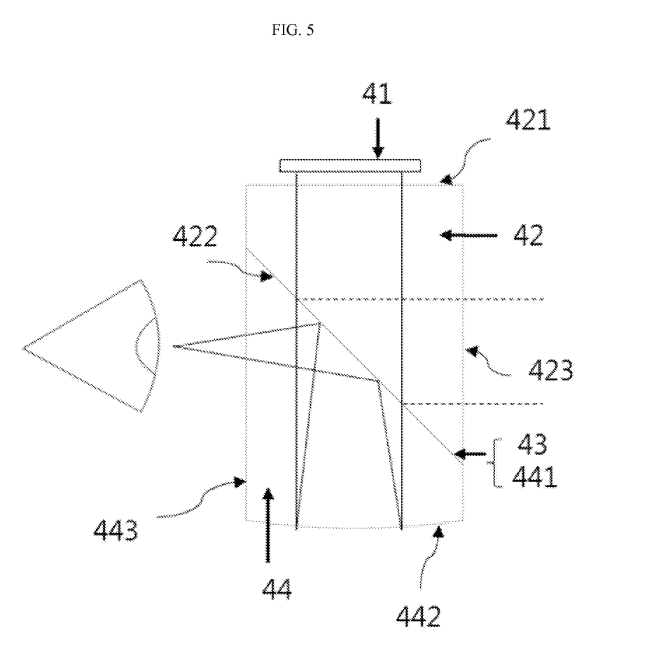

Hereinafter, the optical path of the see-through display device capable of ensuring an ambient field-of-view according to the present invention illustrated in FIG. 4 will be described in greater detail with reference to FIG. 5. FIG. 5 is a cross-sectional view illustrating an optical path of the see-through display device capable of ensuring an ambient field-of-view according to the present invention.

As illustrated in FIG. 5, in an operation in which image light emitted from the display device 41 penetrates the first prism 42 and then emitted, about 50% of a beam is horizontally output externally by the partial reflection filter 43. The remaining 50% of the beam passes through the first incident surface 441 of the second prism 44, and is reflected at the curved reflection surface 442 while having positive power. While reflecting and returning, the remaining 50% of a light intensity is penetrated the partial reflection filter 43 and lost, and the remaining 50% is reflected and is emitted from the emission surface 443 of the second prism 44 and forms an image on the user's pupil.

Therefore, in the see-through display device capable of ensuring an ambient field-of-view according to the present invention, when a light intensity initially generated from the display device 41 is assumed to be 100, a light intensity that is delivered only to the user's eyes other than a lost light intensity due to penetration or reflection is 25. Since this provides brightness double or more the brightness of conventional technology using a beam splitter, it is possible to obtain a very clear image.

Also, in the see-through display device capable of ensuring an ambient field-of-view according to the present invention, since the curved reflection surface 442 providing power is integrally provided below the second prism 44 with the second prism 44, it is possible to decrease a volume compared to a device in which a curved mirror is disposed in front of the user in the related art. Since one optical module is simultaneously responsible for the eyes, its own window function is enabled without a separate housing and it is possible to decrease a weight and a volume. In addition, in the see-through display device capable of ensuring an ambient field-of-view according to the present invention, it is possible to simplify assembly and decrease a manufacturing cost and a product cost per unit. When a center of gravity moves closest to the user's nose, it is possible to stably distribute a weight applied when the user wears goggles.

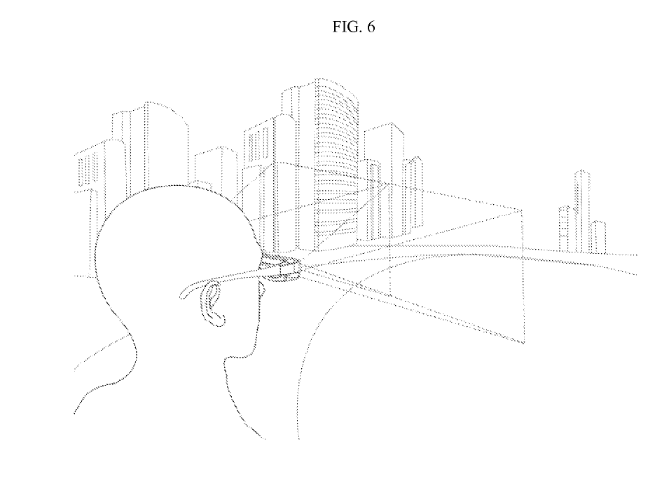

FIG. 6 is a diagram illustrating a state in which the phenomenon of field-of-view occlusion between the eyes is addressed when the see-through display device capable of ensuring an ambient field-of-view according to the present invention is worn. As illustrated in FIG. 6, since an image transmission path for the left eye and an image transmission path for the right eye use the same prism that is connected to each path, there is no obstacle between the eyes that may interfere with a filed-of-view such as a housing or a cutting plane. Accordingly, the user may observe an external image while a wide field-of-view is ensured, similar to an image viewed in a natural state without goggles.

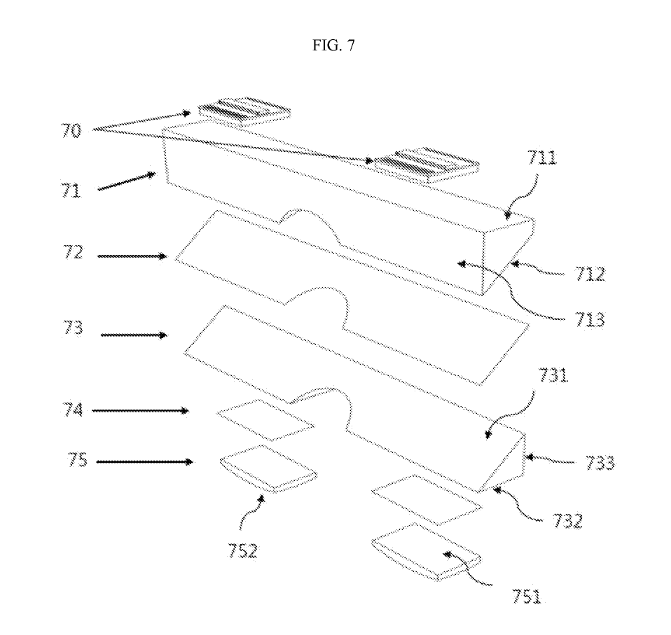

FIG. 7 is an exploded perspective view of a see-through display device capable of ensuring an ambient field-of-view according to another embodiment of the present invention. The see-through display device according to another embodiment of the present invention includes two display devices 70, a first prism 71, a partial reflection filter 72, a second prism 73, two phase shift films 74, and two curved mirrors 75.

In order to further increase light efficiency, in the see-through display device in FIG. 7, the second prism 44 having the curved reflection surface 442 integrally formed therein proposed in the see-through display device in FIG. 4 is separated into the rectangular prism 73 and the curved mirror 75, and the phase shift film 74 is inserted therebetween. In the following description, parts that are the same as in the see-through display device in FIG. 4 will not be described.

As illustrated in FIG. 7, image light emitted from the two display devices 70 is perpendicularly incident within a prism through an incident surface 711 of the first prism 71 that is located in front of the two display devices 70 and has a length greater than an interocular distance, and then emitted from the first prism 71 through a first emission surface 712 that is obliquely disposed.

A certain amount of the emitted image light is reflected at the partial reflection filter 72, is horizontally incident on the first prism 71 again, and is output externally through a second emission surface 713. The image light that is not reflected penetrates the partial reflection filter 72 and is obliquely incident on an incident surface 731 of the second prism 73 that is in contact with the first prism and has a length greater than the interocular distance.

The image light obliquely incident on the incident surface 731 of the second prism 73 is emitted through an emission surface 732, allows an image reflected at the phase shift film 74 and the curved mirror 75 to return to the second prism 73, is reflected at the partial reflection filter 72, and forms an image on a user's pupil. In this case, preferably, the partial reflection filter 72 uses a polarization film.

As described above, the first prism 71 and the second prism 73 having a length greater than the interocular distance are made of the same material and body that can simultaneously induce image light for the left eye and image light for the right eye. Therefore, the user does not experience the phenomenon of field-of-view occlusion since no obstacle is present between the user's eyes. Accordingly, when the user views a penetrating external image, external images provided for the left eye and the right eye become the same so that the user may not become tired and the blind spot is removed and a dangerous situation may be easily recognized even when the user is walking outdoors.

Also, when the partial reflection filter 72 is changed to a polarization filter and a beam is induced by a polarization component according to the above-described configuration, if an initial light intensity of the beam emitted from the display device 70 is assumed to be 100, there is no light loss during a process of forming an image on the user's pupil, other than 50% of a light intensity that is lost when the beam passing through the first prism 71 is reflected at the partial reflection filter 72. Accordingly, it is possible minimize a beam loss and manage the beam more efficiently.

During a process in which the beam penetrating the partial reflection filter 72 passes through the phase shift film 74, is reflected at the curved mirror 75, and returns, a P wave is converted into an S wave, and an S wave is converted into a P wave by the phase shift film 74. Therefore, there is no light loss during a process in which the beam is reflected at the partial reflection filter 72 and forms an image on the user's pupil.

Meanwhile, while the two display devices 70 are used in the above-described embodiment, the embodiment may also be implemented as one display device and a separate optical module that separates an image for both left and right eyes therefrom.

In the present invention, since a wide and open forward situation may be recognized similar to a natural state in which there is no obstacle in a visible region between the eyes, it is possible to prevent an accident due to a blind spot even when the user is wearing the device outdoors or while moving.

Also, in the present invention, since an efficient beam inducing structure is provided, it is possible to obtain a bright and clear image.

Also, in the present invention, since image light is simultaneously provided for the eyes, it is possible to implement a 3D image.

Also, in the present invention, since an optical module is simultaneously responsible for the eyes and its own window function is enabled, it is possible to significantly decrease a weight and a volume without a separate housing, simplify assembly, and decrease a manufacturing cost and a product cost per unit.

As described above, while specific embodiments have been described in the detailed descriptions of the present invention, various modifications may be provided without departing from the spirit and scope of the present invention. Therefore, the scope of the present invention is defined not by the described embodiment but by the appended claims, and encompasses equivalents that fall within the scope of the appended claims.

### REFERENCE NUMERALS

40: display control board
41: display device
42: first prism
421: first prism incident surface
422: first emission surface
423: second emission surface
43: partial reflection filter
44: second prism
441: second prism incident surface
442: curved reflection surface
443: second prism emission surface

What is claimed is:

1. A see-through display device capable of ensuring an ambient field-of-view, comprising:
a display control board;
a display device configured to emit image light according to an image signal generated in the display control board;
a first prism that is located on a bottom surface of the display device, has a length greater than an interocular distance, and includes an incident surface in parallel with the display device, an oblique first emission surface from which image light that has perpendicularly passed through the incident surface is obliquely emitted, and a second emission surface perpendicular to the incident surface;
a partial reflection filter configured to reflect some image light emitted from the first prism and penetrate the remaining image light; and
a second prism that is located on a bottom surface of the partial reflection filter, has a length greater than the interocular distance, and in which an incident surface having the same angle as the emission surface of the first prism, a curved reflection surface in which image light incident on the incident surface is reflected with positive power and is induced to a user' pupil, and an emission surface emitting image light to the user's pupil are integrally formed.

2. The device according to claim 1,
wherein the emission surface of the first prism, the partial reflection filter, and the incident surface of the second prism are bonded by an adhesive such that no air gap is generated.

3. The device according to claim 1,
wherein the second emission surface of the first prism and the emission surface of the second prism are disposed in parallel.

4. A see-through display device capable of ensuring an ambient field-of-view, comprising:
a display control board;
a display device configured to emit image light according to an image signal generated in the display control board;
a first prism that is located on a bottom surface of the display device, has a length greater than an interocular distance, and includes an incident surface in parallel with the display device, and an oblique emission surface from which image light that has perpendicularly passed through the incident surface is obliquely emitted;
a partial reflection filter configured to reflect some image light emitted from the first prism and penetrate the remaining image light;
a second prism that is located on a bottom surface of the partial reflection filter, has a length greater than the interocular distance, and has an incident surface having the same angle as the emission surface of the first prism;
a curved mirror that is located below the second prism, reflects image light emitted from the second prism with positive power, and induces the image light to a user's pupil; and
a phase shift film inserted between a bottom surface of the second prism and a top surface of the curved mirror.

5. The device according to claim 4,
wherein the partial reflection filter is a polarization film.

6. The device according to claim 4,
wherein the emission surface of the first prism, the partial reflection filter, and the incident surface of the second prism are bonded by an adhesive such that no air gap is generated.
